(19) United States
(12) Patent Application Publication
(10) Pub. No.: US 2018/0029473 A1
(43) Pub. Date: Feb. 1, 2018

(54) MOTOR VEHICLE

(71) Applicant: TOYOTA JIDOSHA KABUSHIKI KAISHA, Toyota-shi (JP)

(72) Inventor: Yukimasa NISHIMURA, Toyota-shi (JP)

(73) Assignee: TOYOTA JIDOSHA KABUSHIKI KAISHA, Toyota-shi (JP)

(21) Appl. No.: 15/661,623

(22) Filed: Jul. 27, 2017

(30) Foreign Application Priority Data
Jul. 29, 2016 (JP) 2016-149389

(51) Int. Cl. B60L 3/00; B60W 20/00; B60W 10/06; H02P 3/22; B60W 10/115; B60L 11/18; B60K 6/46; B60L 15/00; B60W 10/08

(52) U.S. Cl. CPC B60L 3/0007; B60L 15/007; B60W 20/00; B60W 10/06; B60W 10/08; B60W 10/115; B60L 11/1861; B60K 6/46; H02P 3/22; B60Y 2200/92; Y10S 903/906; Y10S 903/91; B60Y 2300/43; B60L 2220/14; B60L 2240/42; B60L 2240/486; B60Y 2300/60; Y10S 903/93; B60L 2240/526; B60W 2510/0685; B60W 2710/0644; B60W 2510/08; B60W 2510/246; B60W 2510/244; B60W 2540/10; B60L 2240/547; B60L 2240/549; B60L 2240/545; B60L 2240/421; B60L 2240/427; B60L 2240/441; B60L 11/1879; B60K 6/365

(57) ABSTRACT

In response to detection of a collision of a motor vehicle, the motor vehicle is configured to turn off a relay and to perform three-phase ON control that controls an inverter such as to turn on all switching elements of an upper arm or all switching elements of a lower arm among a plurality of switching elements and converter discharge control that controls a step-up/down converter such as to cause an electric charge of a capacitor to be consumed by the step-up/down converter.

This application claims priority to Japanese Patent Application No. 2016-149389 filed 29 Jul. 2016, the contents of which is incorporated herein by reference.

### TECHNICAL FIELD

The present disclosure relates to a motor vehicle and more specifically relates to a motor vehicle configured to include a three-phase motor, an inverter, a battery, a step-up/down converter, a capacitor and a relay.

### BACKGROUND

A proposed configuration of a motor vehicle includes a three-phase motor configured to output power to an axle; an inverter configured to drive the three-phase motor by switching of a plurality of switching elements; a battery configured to transmit electric power to and from the inverter via a power line; a capacitor mounted to the power line; and a relay provided on a battery side of the capacitor in the power line (as shown in, for example, JP 2013-55822A). This motor vehicle is configured to turn off the relay in response to detection of a collision of the motor vehicle. When the three-phase motor is rotated, this motor vehicle is configured to perform three-phase ON control that controls the inverter to turn on all switching elements of an upper armor all switching elements of a lower arm among the plurality of switching elements. When the three-phase motor stops rotation, on the other hand, this motor vehicle is configured to perform discharge control that controls the inverter such as not to output a torque from the three-phase motor and cause an electric charge of the capacitor to be consumed by the motor.

### SUMMARY

In the motor vehicle described above, when a rotating shaft of the three-phase motor is uncoupled from the axle by the effect of a collision of the vehicle, rotation of the three-phase motor is likely to continue irrespective of a stop of the vehicle. The three-phase ON control of the inverter is performed during rotation of the three-phase motor. This configuration fails to discharge the capacitor and thereby fails to decrease the voltage of the capacitor. This may extend a time period from detection of a collision of the vehicle to the time when the voltage of the capacitor becomes equal to or lower than a predetermined voltage (i.e., the time when discharge of the capacitor is terminated) to a relatively long time.

The motor vehicle of the disclosure thus mainly aims to suppress a time period from detection of a collision of the vehicle to the time when a voltage of a capacitor becomes equal to or lower than a predetermined voltage (i.e., the time when discharge of the capacitor is terminated) from being extended to a relatively long time.

In order to achieve the above object, the motor vehicle of the disclosure is implemented by aspects described below.

According to one aspect of the present disclosure, there is provided a motor vehicle including: a three-phase motor configured to output power to an axle; an inverter configured to drive the three-phase motor by switching of a plurality of switching elements; a battery; a step-up/down converter configured to transmit electric power accompanied with a change in voltage between a low voltage-side power line which the battery is connected with and a high voltage-side power line which the inverter is connected with; a capacitor mounted to the high voltage-side power line; a relay provided in the low voltage-side power line; and a control device configured to control the inverter, the step-up/down converter and the relay, wherein in response to detection of a collision of the motor vehicle, the control device is configured to turn off the relay and to perform three-phase ON control that controls the inverter such as to turn on all switching elements of an upper arm or all switching elements of a lower arm among the plurality of switching elements and converter discharge control that controls the step-up/down converter such as to cause an electric charge of the capacitor to be consumed by the step-up/down converter.

In response to detection of a collision of the motor vehicle, the motor vehicle of this aspect is configured to turn off the relay and to perform the three-phase ON control that controls the inverter such as to turn on all the switching elements of the upper arm or all the switching elements of the lower arm among the plurality of switching elements and the converter discharge control that controls the step-up/down converter such as to cause the electric charge of the capacitor to be consumed by the step-up/down converter. This configuration enables the capacitor to be discharged even during rotation of the three-phase motor after the relay is turned off in response to detection of a collision of the vehicle. This configuration accordingly suppresses a time period from detection of a collision of the vehicle to the time when the voltage of the capacitor becomes equal to or lower than a predetermined voltage (i.e., the time when discharge of the capacitor is terminated) from being extended to a relatively long time.

### BRIEF DESCRIPTION OF DRAWINGS

FIG. 1 is a configuration diagram illustrating the schematic configuration of a hybrid vehicle according to one embodiment of the present disclosure;

FIG. 2 is a configuration diagram illustrating the schematic configuration of an electrical driving system including motors MG1 and MG2;

FIG. 3 is a flowchart showing one example of a collision detection control routine according to the embodiment;

FIG. 4 is a diagram illustrating one example of the operations in response to detection of a collision of the vehicle;

FIG. 5 is a flowchart showing another example of the collision detection control routine according to a modification;

FIG. 6 is a flowchart showing another example of the collision detection control routine according to another modification;

FIG. 7 is a diagram illustrating one example of the operations in response to detection of a collision of the vehicle according to the modification;

FIG. 8 is a configuration diagram illustrating the schematic configuration of a hybrid vehicle according to a modification;

FIG. 9 is a configuration diagram illustrating the schematic configuration of a hybrid vehicle according to another modification;

FIG. 10 is a configuration diagram illustrating the schematic configuration of a hybrid vehicle according to another modification;

FIG. 11 is a configuration diagram illustrating the schematic configuration of a hybrid vehicle according to another modification; and

FIG. 12 is a configuration diagram illustrating the schematic configuration of an electric vehicle according to another modification.

### DESCRIPTION OF EMBODIMENTS

The following describes some aspects of the present disclosure with reference to embodiments.

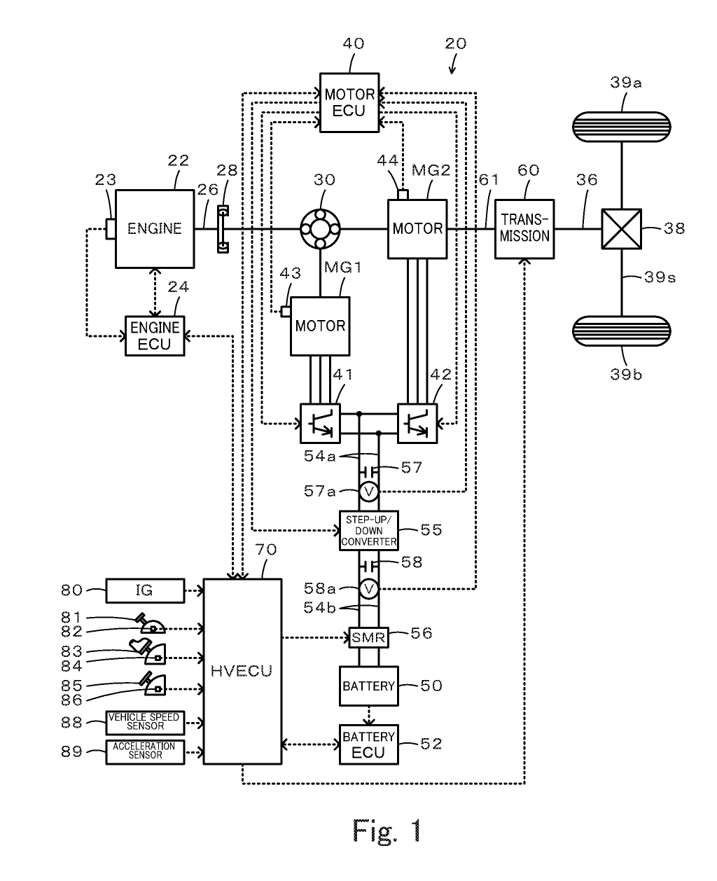

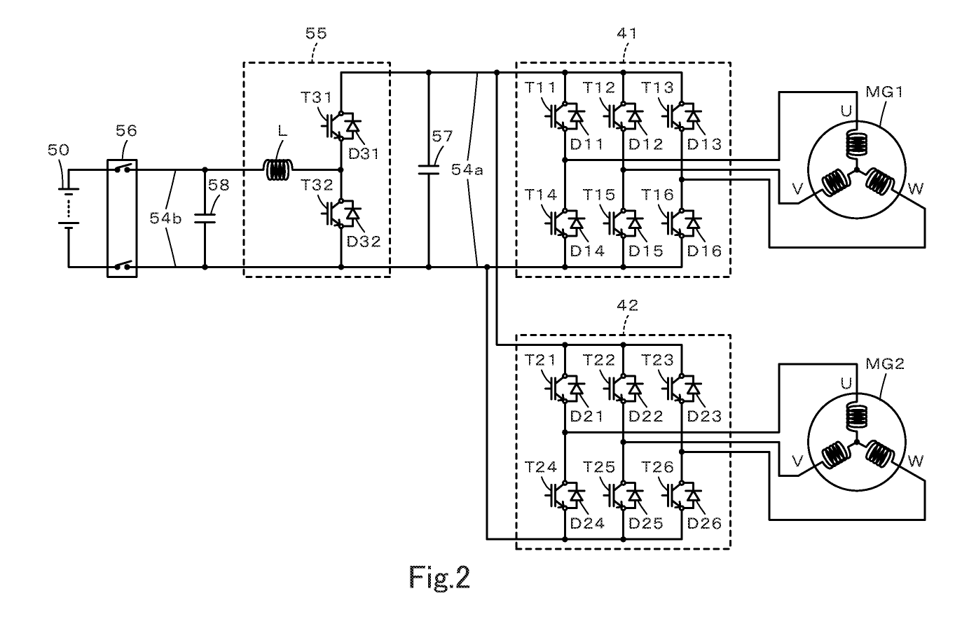

FIG. 1 is a configuration diagram illustrating the schematic configuration of a hybrid vehicle 20 according to one embodiment of the present disclosure. FIG. 2 is a configuration diagram illustrating the schematic configuration of an electrical driving system including motors MG1 and MG2. As shown in FIG. 1, the hybrid vehicle 20 of the embodiment includes an engine 22, a planetary gear 30, motors MG1 and MG2, inverters 41 and 42, a battery 50, a step-up/down converter 55, a system main relay 56, a transmission 60 and a hybrid electronic control unit (hereinafter referred to as “HVECU”) 70.

The engine 22 is configured as an internal combustion engine to output power using, for example, gasoline or light oil as a fuel. This engine 22 is operated and controlled by an engine electronic control unit (hereinafter referred to as “engine ECU”) 24.

The engine ECU 24 is configured as a CPU-based microprocessor and includes a ROM configured to store processing programs, a RAM configured to temporarily store data, input/output ports and a communication port, in addition to the CPU, although not being illustrated. The engine ECU 24 receives signals input from various sensors required for operation control of the engine 22 via the input port, for example, a crank angle θcr from a crank position sensor 23 configured to detect the rotational position of a crankshaft 26 of the engine 22. The engine ECU 24 outputs various control signals for the operation control of the engine 22 via the output port. The engine ECU 24 is connected with the HVECU 70 via the respective communication ports. The engine ECU 24 calculates a rotation speed Ne of the engine 22, based on the crank angle θcr input from the crank position sensor 23.

The planetary gear 30 is configured as a single pinion-type planetary gear mechanism. The planetary gear 30 includes a sun gear that is connected with a rotor of the motor MG1. The planetary gear 30 also includes a ring gear that is connected with an input shaft 61 of the transmission and with a rotor of the motor MG2. The planetary gear 30 further includes a carrier that is connected with the crankshaft 26 of the engine 22 via a damper 28.

The motor MG1 is configured as a synchronous motor generator having a rotor with permanent magnets embedded therein and a stator with three-phase coils wound thereon. As illustrated, this rotor is connected with the sun gear of the planetary gear 30. Like the motor MG1, the motor MG2 is configured as a synchronous motor generator having a rotor with permanent magnets embedded therein and a stator with three-phase coils wound thereon. This rotor is connected with the ring gear of the planetary gear 30 and with the input shaft 61 of the transmission 60.

As shown in FIG. 2, the inverter 41 is connected with high voltage-side power lines 54a. This inverter 41 is configured to include six transistors T11 to T16 and six diodes D11 to D16 that are connected in parallel to and in a reverse direction to the transistors T11 to T16. The transistors T11 to T16 are arranged in pairs, such that two transistors in each pair respectively serve as a source and a sink relative to a positive electrode line and a negative electrode line of the high voltage-side power lines 54a. The respective phases of the three-phase coils (U phase, V phase and W phase) of the motor MG1 are connected with connection points of the respective pairs of the transistors T11 to T16. Accordingly, when a voltage is applied to the inverter 41, a motor electronic control unit (hereinafter referred to as “motor ECU”) 40 serves to regulate the rates of ON times of the respective pairs of the transistors T11 to T16, such as to provide a rotating magnetic field in the three-phase coils and thereby rotate and drive the motor MG1. Like the inverter 41, the inverter 42 is also connected with the high voltage-side power lines 54a and is configured to include six transistors T21 to T26 and six diodes D21 to D26. When a voltage is applied to the inverter 42, the motor ECU 40 serves to regulate the rates of ON times of the respective pairs of the transistors T21 to T26, such as to provide a rotating magnetic field in the three-phase coils and thereby rotate and drive the motor MG2. In the description below, the transistors T11 to T13 of the inverter 41 and the transistors T21 to T23 of the inverter 42 may be called “upper arm”, and the transistors T14 to T16 of the inverter 41 and the transistors T24 to T26 of the inverter 42 may be called “lower arm”.

The step-up/down converter 55 is connected with the high voltage-side power lines 54a with which the inverters 41 and 42 are connected and with low voltage-side power lines 54b with which the battery 50 is connected. This step-up/down converter 55 is configured to include two transistors T31 and T32, two diodes D31 and D32 connected in parallel to and in a reverse direction to the transistors T31 and T32, and a reactor L. The transistor T31 is connected with the positive electrode line of the high voltage-side power lines 54a. The transistor T32 is connected with the transistor 31 and with negative electrode lines of the high voltage-side power lines 54a and of the low voltage-side power lines 54b. The reactor L is connected with a connection point between the transistors T31 and T32 and with a positive electrode line of the low voltage-side power lines 54b. The motor ECU 40 serves to regulate the rates of ON times of the transistors T31 and T32, such that the step-up/down converter 55 steps up an electric power of the low voltage-side power lines 54b and supplies the stepped-up electric power to the high voltage-side power lines 54a, while stepping down an electric power of the high voltage-side power lines 54a and supplying the stepped-down electric power to the low voltage-side power lines 54b. The transistor T31 of the step-up/down converter 55 may be called “upper arm”, and the transistor T32 of the step-up/down converter 55 may be called “lower arm”. A smoothing capacitor 57 is mounted to the positive electrode line and the negative electrode line of the high voltage-side power lines 54a. A smoothing capacitor 58 is mounted to the positive electrode line and the negative electrode line of the low voltage-side power lines 54b.

The motor ECU 40 is configured as a CPU-based microprocessor and includes a ROM configured to store processing programs, a RAM configured to temporarily store data, input/output ports and a communication port, in addition to the CPU, although not being illustrated. As shown in FIG. 1, the motor ECU 40 receives signals input from various sensors required for drive control of the motors MG1 and MG2 and the step-up/down converter 55 via the input port. The signals input into the motor ECU 40 include, for example, rotational positions θm1 and θm2 from rotational position detection sensors 43 and configured to detect the rotational positions of the respective rotors of the motors MG1 and MG2. The input signals also include a voltage VH of the capacitor 57 (i.e., voltage of the high voltage-side power lines 54a) from a voltage sensor 57a mounted between terminals of the capacitor 57 and a voltage VL of the capacitor 58 (i.e., voltage of the low voltage-side power lines 54b) from a voltage sensor 58a mounted between terminals of the capacitor 58. The motor ECU 40 outputs, for example, switching control signals to the transistors T11 to T16 of the inverter 41 and the transistors T21 to T26 of the inverter 42 and switching control signals to the transistors T31 and T32 of the step-up/down converter 55 via the output port. The motor ECU 40 is connected with the HVECU 70 via the respective communication ports. The motor ECU 40 calculates rotation speeds Nm1 and Nm2 of the respective motors MG1 and MG2, based on the rotational positions θm1 and θm2 of the respective rotors of the motors MG1 and MG2 input from the rotational position detection sensors 43 and 44.

The battery 50 may be configured by, for example, a lithium ion rechargeable battery or a nickel metal hydride battery and is connected with the low voltage-side power lines 54b. This battery 50 is under management of a battery electronic control unit (hereinafter referred to as “battery ECU”) 52.

The battery ECU 52 is configured as a CPU-based microprocessor and includes a ROM configured to store processing programs, a RAM configured to temporarily store data, input/output ports and a communication port, in addition to the CPU, although not being illustrated. The battery ECU 52 receives signals input from various sensors required for management of the battery 50 via the input port. The signals input into the battery ECU 52 include, for example, a battery voltage Vb from a voltage sensor placed between terminals of the battery 50, a battery current Ib from a current sensor mounted to an output terminal of the battery 50, and a battery temperature Tb from a temperature sensor mounted to the battery 50. The battery ECU 52 is connected with the HVECU 70 via the respective communication ports. The battery ECU 52 calculates a state of charge SOC of the battery 50, based on an integrated value of the battery current Ib from the current sensor. The state of charge SOC denotes a ratio of the capacity of electric power dischargeable from the battery 50 to the overall capacity of the battery 50.

The system main relay 56 is provided on a battery 50-side of the capacitor 58 in the low voltage-side power lines 54b. The HVECU 70 controls on and off this system main relay 56, such that the system main relay 56 connects and disconnects the battery 50 with and from a step-up/down converter 55-side in the low voltage-side power lines 54b.

The transmission 60 is configured as a four-speed transmission to include an input shaft 61 that is connected with the ring gear of the planetary gear 30 and with the rotor of the motor MG2, an output shaft serving as a driveshaft 36 that is coupled with drive wheels 39a and 39b via an axle 39s and a differential gear 38, a plurality of planetary gears, and a plurality of hydraulically-driven frictional engagement elements (clutches and brakes). This transmission 60 is controlled by the HVECU 70, such as to change gear among first to fourth forward gear positions, neutral position and first back gear position.

The HVECU 70 is configured as a CPU-based microprocessor and includes a ROM configured to store processing programs, a RAM configured to temporarily store data, input/output ports and a communication port, in addition to the CPU, although not being illustrated. The HVECU 70 receives signals input from various sensors via the input port. The signals input into the HVECU 70 include, for example, an ignition signal from an ignition switch 80 and a shift position SP from a shift position sensor 82 configured to detect an operating position of a shift lever 81. The input signals also include an accelerator position Acc from an accelerator pedal position sensor 84 configured to detect a depression amount of an accelerator pedal 83, a brake pedal position BP from a brake pedal position sensor 86 configured to detect a depression amount of a brake pedal 85, and a vehicle speed V from a vehicle speed sensor 88. The input signals further include a vehicle body acceleration α from acceleration sensors 89 provided, for example, on a center and on both sides in a vehicle front side. The HVECU 70 is connected with the engine ECU 24, the motor ECU 40 and the battery ECU 52 via the respective communication ports as described above.

The hybrid vehicle 20 of the embodiment having the configuration described above may be driven in a hybrid drive (HV drive) mode or in an electric drive (EV) drive mode. The HV drive mode is a drive mode with operation of the engine 22, and the EV drive mode is a drive mode without operation of the engine 22.

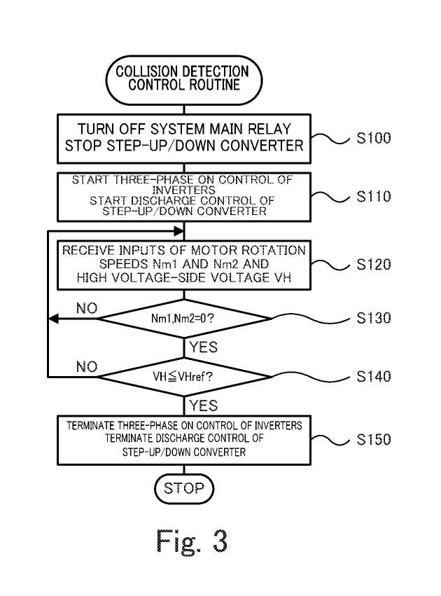

The following describes operations of the hybrid vehicle 20 of the embodiment having the above configuration and more specifically series of operations in response to detection of a collision of the vehicle. FIG. 3 is a flowchart showing one example of a collision detection control routine performed by the HVECU 70 according to the embodiment. This routine is triggered by detection of a collision of the vehicle. According to this embodiment, a collision of the vehicle is detected when the vehicle speed acceleration α detected by the acceleration sensors 89 exceeds a reference value αref for collision detection. When a collision of the vehicle is detected during operation of the engine 22, the operation of the engine 22 is to be stopped.

When the collision detection control routine is triggered, the HVECU 70 first turns off the system main relay 56 and sends an operation stop command of the step/up/down converter 55 to the motor ECU 40 (step S100). When receiving this operation stop command, the motor ECU 40 stops the operation of the step-up/down converter 55.

The HVECU 70 subsequently starts three-phase ON control of the inverters 41 and 42 and sends a control start command for discharge control of the step-up/down converter 55 (hereinafter referred to as “converter discharge control”) to the motor ECU 40 (step S110). When receiving this control start command, the motor ECU 40 starts the converter discharge control.

The three-phase ON control of the inverter 41 denotes a control process of either turning on all the transistors T11 to T13 (upper arm) among the transistors T11 to T16 of the inverter 41 while turning off all the transistors T14 to T16 (lower arm) or turning off all the transistors T11 to T13 (upper arm) while turning on all the transistors T14 to T16 (lower arm). The three-phase ON control of the inverter 42 is performed similarly to the three-phase ON control of the inverter 41. Performing the three-phase ON control of the inverters 41 and 42 in the state that the motors MG1 and MG2 are rotated generates torques (drag torques) in a direction of reducing the absolute values of the rotation speeds Nm1 and Nm2 of the motors MG1 and MG2 and thereby stops the rotations of the motors MG1 and MG2.

The converter discharge control denotes a control process of controlling the step-up/down converter 55, such as to cause electric charges of the capacitor 57 and the capacitor 58 to be consumed by the step-up/down converter 55. According to this embodiment, the converter discharge control sets a duty D of the transistors T31 and T32 to a predetermined value D1 (for example, 50%) and performs switching control of the transistors T31 and T32 of the step-up/down converter 55. The duty D herein denotes a ratio of the ON time of the transistor T32 (lower arm) to the sum of the ON time of the transistor T31 (upper arm) and the ON time of the transistor T32 (lower arm). When the converter discharge control is performed to turn off the transistor T31 and turn on the transistor T32, the electric charges of the capacitor 58 are consumed as a loss of the reactor L and the transistor T32. When the converter discharge control is performed to turn on the transistor T31 and turn off the transistor T32, on the other hand, the electric charges of the capacitor 57 are consumed as a loss of the transistor T31 and the reactor L. The converter discharge control enables the capacitor 57 and the capacitor 58 to be discharged in this manner, such as to decrease the voltage of the high voltage-side power lines 54a and the voltage of the low voltage-side power lines 54b.

After starting the three-phase ON control of the inverters 41 and 42 and the converter discharge control, the HVECU 70 receives the inputs of the rotation speeds Nm1 and Nm2 of the motors MG1 and MG2 and the voltage VH of the capacitor 57 (step S120). The rotation speeds Nm1 and Nm2 of the motors MG1 and MG2 are calculated based on the rotational positions θm1 and θm2 of the respective rotors of the motors MG1 and MG2 from the rotational position detection sensors 43 and 44 and are input from the motor ECU 40 by communication. The voltage VH of the capacitor 57 is detected by the voltage sensor 57a and is input from the motor ECU 40 by communication.

The HVECU 70 subsequently determines whether both the rotation speeds Nm1 and Nm2 of the motors MG1 and MG2 are equal to value 0 (step S130) and compares the voltage VH of the capacitor 57 with a reference value VHref (step S140). The reference value VHref is used to determine whether discharge of the capacitor 57 (and the capacitor 58) is to be terminated and may be, for example, 50 V, 60V or 70 V.

When it is determined at step S130 that at least one of the rotation speeds Nm1 and Nm2 of the motors MG1 and MG2 is not equal to the value 0 or when it is determined at step S140 that the voltage VH of the capacitor 57 is higher than the reference value VHref, the HVECU 70 goes back to step S120.

When it is determined at step S130 that both the rotation speeds Nm1 and Nm2 of the motors MG1 and MG2 are equal to the value 0 and it is determined at step S140 that the voltage VH of the capacitor 57 is equal to or lower than the reference value VHref, on the other hand, the HVECU 70 terminates the three-phase ON control of the inverters 41 and 42 and sends a control stop command for the converter discharge control to the motor ECU 40 (step S150) and terminates this routine. When receiving this control stop command, the motor ECU 40 terminates the converter discharge control.

In the event of a collision of the vehicle, the rotation of the motor MG2 is generally stopped, accompanied with stop of the vehicle (i.e., stop of the rotation of the drive wheels 39a and 39b). The effect of the collision is, however, likely to uncouple the driveshaft 36 (i.e., the rotating shaft of the motor MG2) from the axle 39s or to change gear of the transmission 60 to the neutral position. This may result in continuing the rotation of the motor MG2, in spite of the stop of the vehicle. In the event of a collision of the vehicle, the motor MG1 is rotated in many cases. Accordingly the control procedure of this embodiment turns off the system main relay 56 in response to detection of the collision of the vehicle and subsequently performs the three-phase ON control of the inverters 41 and 42, such as not to supply an electric power caused by generation of a back electromotive force accompanied with the rotation of the motors MG1 and MG2, to the capacitor 57. The procedure of this embodiment performs the converter discharge control, in addition to the three-phase ON control of the inverters 41 and 42. This enables the capacitor 57 and the capacitor 58 to be discharged even during the rotation of the motors MG1 and MG2, such as to decrease the voltage VH of the capacitor 57 and the voltage VL of the capacitor 58. This configuration accordingly suppresses the time period from detection of a collision of the vehicle to the time when the voltage VH of the capacitor 57 becomes equal to or lower than the reference value VHref (i.e., when discharge of the capacitor 57 (and the capacitor 58) is terminated) from being extended to a relatively long time.

The control procedure of the embodiment continues the three-phase ON control of the inverters 41 and 42 and the converter discharge control until both the rotation speeds Nm1 and Nm2 of the motors MG1 and MG2 become equal to the value 0 and the voltage VH of the capacitor 57 becomes equal to or lower than the reference value Vhref. The three-phase ON control and the converter discharge control are performed until both the rotation speeds Nm1 and Nm2 of the motors MG1 and MG2 become equal to the value 0, i.e., until generation of a back electromotive force is stopped accompanied with the rotation of the motors MG1 and MG2. This configuration accordingly suppresses the electric power caused by generation of the back electromotive force accompanied with the rotation of the motors MG1 and MG2 from being supplied to the capacitor 57 and thereby suppresses the voltage VH of the capacitor 57 from becoming higher than the reference value VHref, after termination of the three-phase ON control and the converter discharge control.

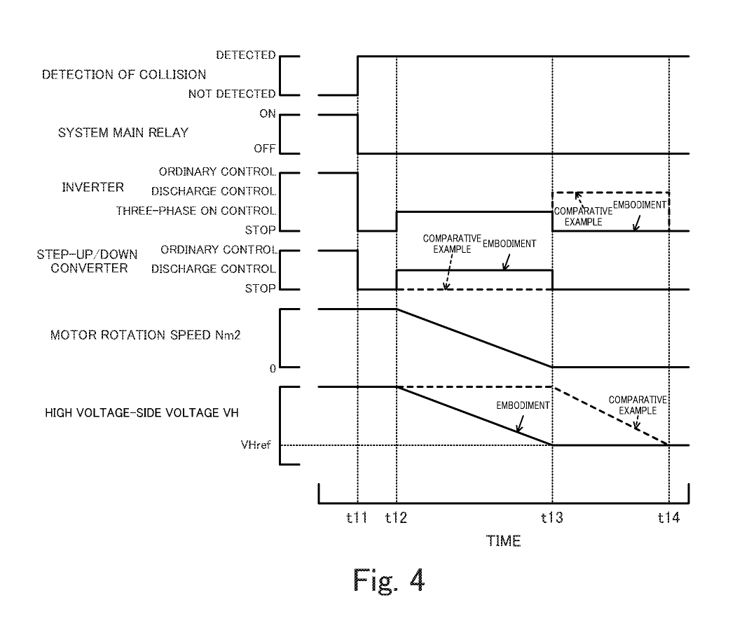

FIG. 4 is a diagram illustrating one example of the operations in response to detection of a collision of the vehicle. In the diagram, solid lines indicate the operations of the embodiment and broken lines indicate the operations of a comparative example, with regard to the control of the inverters 41 and 42, the control of the step-up/down converter 55 and a change in the voltage VH of the capacitor 57. The comparative example controls the step-up/down converter 55 and the inverters 41 and 42 as described below. The comparative example stops the operation of the step-up/down converter 55, whether both the rotation speeds Nm1 and Nm2 of the motors MG1 and MG2 are equal to the value 0 or not. When at least one of the rotation speeds Nm1 and Nm2 of the motors MG1 and MG2 is not equal to the value 0, the comparative example performs the three-phase ON control of the inverters 41 and 42. When both the rotation speeds Nm1 and Nm2 of the motors MG1 and MG2 are equal to the value 0, on the other hand, the comparative example performs inverter discharge control that controls the inverters 41 and 42 such as to output no torques from the motors MG1 and MG2 and such as to cause the electric charges of the capacitor 57 and the capacitor 58 to be consumed by the motors MG1 and MG2. The discharge control of the inverters 41 and 42 is generally performed by controlling the inverters 41 and 42 such as to cause d-axis current to flow in the motors MG1 and MG2. In this state, when the voltage VH of the capacitor 57 becomes lower relative to the voltage VL of the capacitor 58, the electric charges of the capacitor 58 are supplied from the capacitor 58 to the motors MG1 and MG2 via the low voltage-side power lines 54b, the diode D31 of the step-up/down converter 55, the high voltage-side power lines 54a and the inverters 41 and 42 and are consumed by the motors MG1 and MG2.

Both the embodiment and the comparative example turn off the system main relay 56, in response to detection of a collision of the vehicle at a time t11. The comparative example starts the three-phase ON control of the inverters 41 and 42 at a time t12 and changes over the control of the inverters 41 and 42 from the three-phase ON control to the inverter discharge control when the rotation speed Nm2 of the motor MG2 (and the rotation speed Nm1 of the motor MG1) become equal to the value 0 at a time t13. When the voltage VH of the capacitor 57 subsequently becomes equal to or lower than the reference value VHref at a time t14, the comparative example terminates the inverter discharge control. As described above, when the rotation speed Nm2 of the motor MG2 is not equal to the value 0, the comparative example fails to discharge the capacitor 57 and thereby fails to decrease the voltage VH of the capacitor 57. This may extend the time period from detection of a collision of the vehicle to the time when the voltage VH of the capacitor 57 becomes equal to or lower than the reference value VHref to a relatively long time. The embodiment, on the other hand, starts the three-phase ON control of the inverters 41 and 42 and the converter discharge control at the time t12 and terminates the three-phase ON control of the inverters 41 and 42 and the converter discharge control when the rotation speed Nm2 of the motor MG2 (and the rotation speed Nm1 of the motor MG1) become equal to the value 0 and the voltage VH of the capacitor 57 becomes equal to or lower than the reference value VHref at the time t13 that is prior to the time t14. As described above, when the rotation speed Nm2 of the motor MG2 is not equal to the value 0, the embodiment enables the capacitor 57 to be discharged such as to decrease the voltage VH of the capacitor 57. Compared with the comparative example, this configuration of the embodiment accordingly shortens the time period from detection of a collision of the vehicle to the time when the voltage VH of the capacitor 57 becomes equal to or lower than the reference value VHref (i.e., when discharge of the capacitor 57 (and the capacitor 58) is terminated).

The hybrid vehicle 20 of the embodiment described above turns off the system main relay 56 and performs the three-phase ON control of the inverters 41 and 42 and the converter discharge control, in response to detection of a collision of the vehicle. This configuration enables the capacitor 57 to be discharged even during rotation of the motors MG1 an MG2 after the system main relay 56 is turned off in response to detection of a collision of the vehicle. This configuration accordingly suppresses the time period from detection of a collision of the vehicle to the time when the voltage VH of the capacitor 57 becomes equal to or lower than the reference value VHref (i.e., when discharge of the capacitor 57 (and the capacitor 58) is terminated) from being extended to a relatively long time.

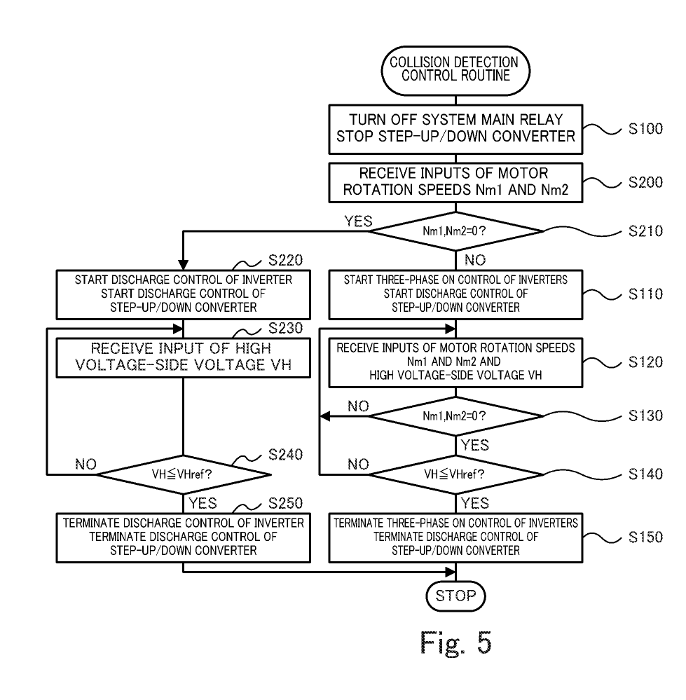

The hybrid vehicle 20 of the embodiment performs the collision detection control routine of FIG. 3, in response to detection of a collision of the vehicle. According to a modification, in response to detection of a collision of the vehicle, a collision detection control routine of FIG. 5 may be performed, in place of the collision detection control routine of FIG. 3. The collision detection control routine of FIG. 5 is similar to the collision detection control routine of FIG. 3, except addition of steps S200 to S250 to the collision detection control routine of FIG. 3. The like steps are expressed by the like step numbers, and their detailed description is omitted.

In the collision detection control routine of FIG. 5, after turning off the system main relay 56 and stopping the operation of the step-up/down converter 55 at step S100, the HVECU 70 receives the inputs of the rotation speed Nm1 and Nm2 of the motors MG1 and MG2 (step S200) and determines whether both the rotation speeds Nm1 and Nm2 of the motors MG1 and MG2 are equal to value 0 (step S210). When it is determined that at least one of the rotation speeds Nm1 and Nm2 of the motors MG1 and MG2 is not equal to the value 0, the HVECU 70 performs the processing of steps S110 to S150 described above and terminates this routine.

When it is determined at step S210 that both the rotation speeds Nm1 and Nm2 of the motors MG1 and MG2 are equal to the value 0, on the other hand, the HVECU 70 starts the inverter discharge control and sends a control start command for the converter discharge control to the motor ECU 40 (step S220). When receiving this control start command, the motor ECU 40 starts the converter discharge control.

The HVECU 70 subsequently receives the input of the voltage VH of the capacitor 57 (step S230) and compares the input voltage VH of the capacitor 57 with the reference value VHref (step S240). When the voltage VH of the capacitor 57 is higher than the reference value VHref, the HVECU 70 returns to step S230. When the voltage VH of the capacitor 57 is equal to or lower than the reference value VHref, on the other hand, the HVECU 70 terminates the inverter discharge control and sends a control stop command for the converter discharge control to the motor ECU 40 (step S250) and terminates this routine. When receiving the control stop command, the motor ECU 40 terminates the converter discharge control.

As described above, this modification performs both the inverter discharge control and the converter discharge control when both the rotation speeds Nm1 and Nm2 of the motors MG1 and MG2 are equal to the value 0 immediately after the system main relay 56 is turned off in response to detection of a collision of the vehicle. The configuration of this modification accordingly shortens the time period elapsed until the voltage VH of the capacitor 57 becomes equal to or lower than the reference value VHref, compared with the configuration that performs only one of the inverter discharge control and the converter discharge control.

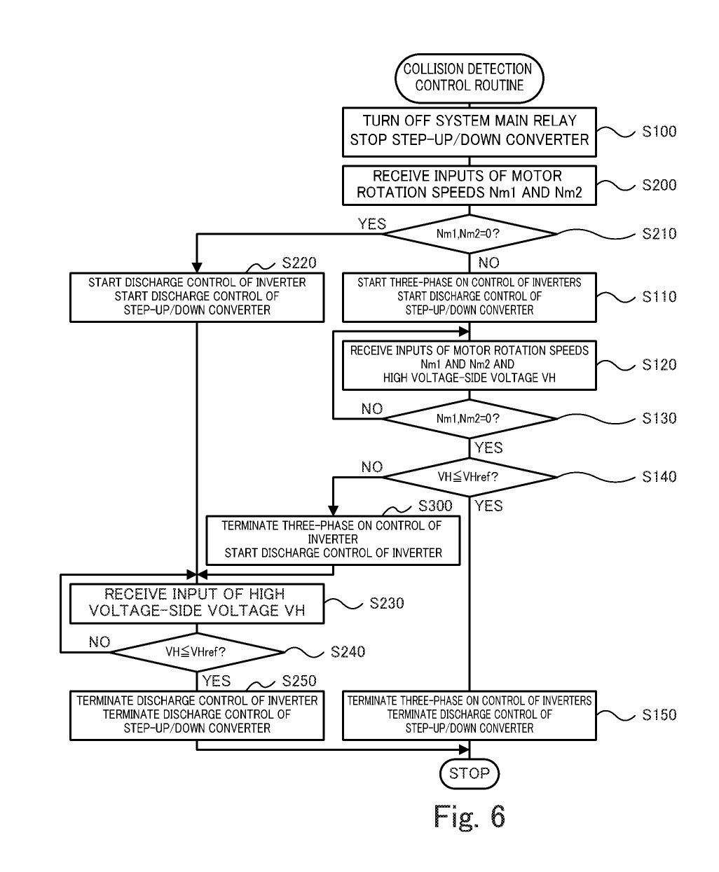

The hybrid vehicle 20 performs the collision detection control routine of FIG. 3 according to the embodiment and performs the collision detection control routine of FIG. 5 according to the above modification. According to another modification, in response to detection of a collision of the vehicle, a collision detection control routine of FIG. 6 may be performed, in place of the collision detection control routine of FIG. 3 or FIG. 5. The collision detection control routine of FIG. 6 is similar to the collision detection control routine of FIG. 5, except addition of step S300 to the collision detection control routine of FIG. 5. The like steps are expressed by the like step numbers, and their detailed description is omitted.

In the collision detection control routine of FIG. 6, after starting the three-phase ON control of the inverters 41 and 42 and the converter discharge control (step S110), when it is determined that both the rotation speeds Nm1 and Nm2 of the motors MG1 and MG2 are equal to the value 0 (step S130), the HVECU 70 subsequently compares the voltage VH of the capacitor 57 with the reference value VHref (step S140). When the voltage VH of the capacitor 57 is equal to or lower than the reference value VHref, the HVECU 70 performs the processing of step S150 and terminates this routine.

When the voltage VH of the capacitor 57 is higher than the reference value VHref at step S140, on the other hand, the HVECU 70 terminates the three-phase ON control of the inverters 41 and 42 and starts the inverter discharge control (step S300). This configuration accordingly performs both the inverter discharge control and the converter discharge control. The HVECU 70 subsequently performs the processing of steps S230 to S250 and terminates this routine.

As described above, this modification performs both the inverter discharge control and the converter discharge control when both the rotation speeds Nm1 and Nm2 of the motors MG1 and MG2 become equal to the value 0 but the voltage VH of the capacitor 57 is higher than the reference value VHref during the three-phase ON control of the inverters 41 and 42 and the converter discharge control performed after the system main relay 56 is turned off in response to detection of a collision of the vehicle. The configuration of this modification accordingly shortens the time period elapsed until the voltage VH of the capacitor 57 becomes equal to or lower than the reference value VHref, compared with the configuration that performs the three-phase ON control of the inverters 41 and 42 and the converter discharge control like the embodiment and the configuration that performs the inverter discharge control and stops the operation of the step-up/down converter 55 when both the rotation speeds Nm1 and M2 of the motors MG1 and MG2 are equal to the value 0 and the voltage VH of the capacitor 57 is higher than the reference value VHref.

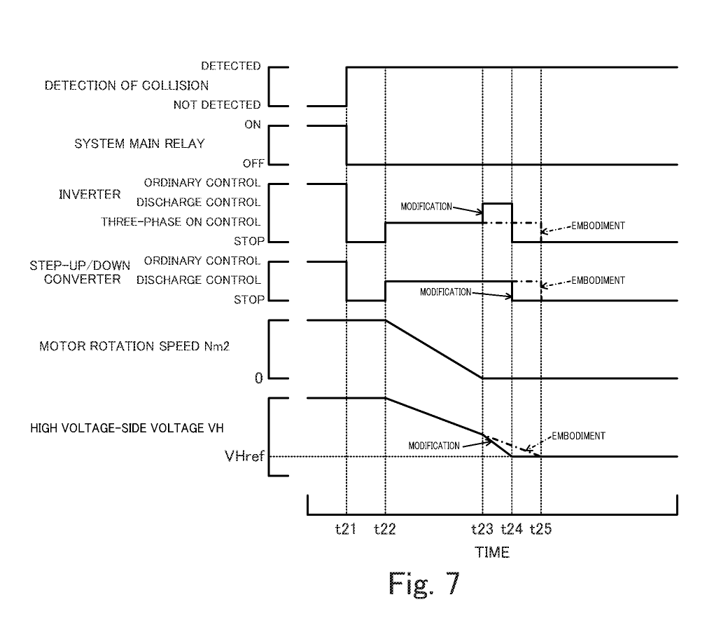

FIG. 7 is a diagram illustrating one example of the operations in response to detection of a collision of the vehicle. In the diagram, solid lines indicate the operations of this modification (in which the collision detection control routine of FIG. 6 is performed) and one-dot chain lines indicates the operations of the embodiment described above (in which the collision detection control routine of FIG. 3 is performed), with regard to the control of the inverters 41 and 42, the control of the step-up/down converter 55 and a change in the voltage VH of the capacitor 57. Both the embodiment and the modification turn off the system main relay 56 in response to detection of a collision of the vehicle at a time t21 and start the three-phase ON control of the inverters 41 and 42 and the converter discharge control at a time t22. When the rotation speed Nm2 of the motor MG2 (and the rotation speed Nm1 of the motor MG1) are equal to the value 0 and the voltage VH of the capacitor 57 becomes equal to or lower than the reference value VHref at a time t25, the embodiment terminates the three-phase ON control of the inverters 41 and 42 and the converter discharge control. The modification, on the other hand, changes over the control of the inverters 41 and 42 from the three-phase ON control to the converter discharge control when the rotation speed Nm2 of the motor MG2 becomes equal to the value 0 at a time t23 before the voltage VH of the capacitor 57 becomes equal to or lower than the reference value VHref. This configuration enables the electric charges of the capacitor 57 and the capacitor 58 to be consumed by the motors MG1 and MG2 and the step-up/down converter 55 and thereby further accelerates discharging the capacitor 57 and the capacitor 58. When the voltage VH of the capacitor 57 becomes equal to or lower than the reference value VHref at a time t24 prior to the time t25, the modification terminates the inverter discharge control and the converter discharge control. The configuration of this modification further shortens the time period from detection of a collision of the vehicle to the time when the voltage VH of the capacitor 57 becomes equal to or lower than the reference value VHref, compared with the configuration of the embodiment.

The hybrid vehicle 20 of the embodiment employs the four-speed transmission for the transmission 60. Another type of transmission, for example, a three-speed transmission, a five-speed transmission, a six-speed transmission, an eight-speed transmission or a ten-speed transmission may also be employed for the transmission 60.

The hybrid vehicle 20 of the embodiment is configured to include the engine ECU 24, the motor ECU 40 and the HVECU 70. According to a modification, the engine ECU 24, the motor ECU 40 and the HVECU 70 may be configured by a single electronic control unit.

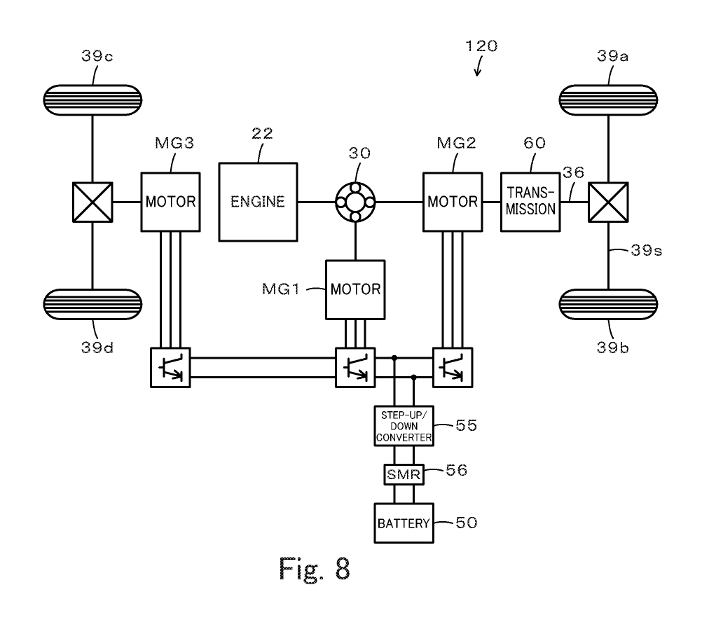

The hybrid vehicle 20 of the embodiment is configured such that the ring gear of the planetary gear 30 and the motor MG2 are connected via the transmission 60 with the driveshaft 36 that is coupled with the drive wheels 39a and 39b and that the sun gear and the carrier of the planetary gear 30 are respectively connected with the motor MG1 and the engine 22. As shown in FIG. 8, however, a hybrid vehicle 120 of a modification may be configured to further include a motor MG3 that is coupled with wheels 39c and 39d different from the drive wheels 39a and 39b, in addition to the configuration of the hybrid vehicle 20.

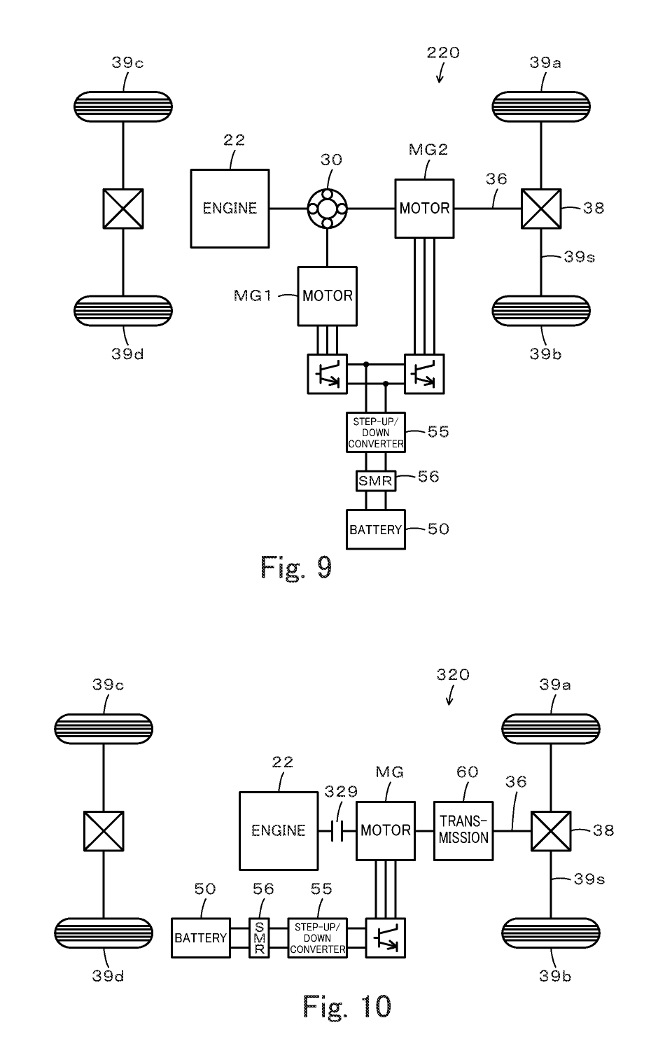

The hybrid vehicle 20 of the embodiment is configured such that the transmission 60 is placed between the driveshaft 36 that is coupled with the drive wheels 39a and 39b, and the ring gear of the planetary gear 30 and the motor MG2. As shown in FIG. 9, however, a hybrid vehicle 220 of a modification may be configured to exclude a transmission and directly connect the drive shaft 36 with the ring gear of the planetary gear 30 and with the motor MG2. Another modification may be configured to include a motor that is coupled with wheels 39c and 39d different from the drive wheels 39a and 39b, in addition to the configuration of the hybrid vehicle 220.

The hybrid vehicle 20 of the embodiment is configured such that the ring gear of the planetary gear 30 and the motor MG2 are connected via the transmission 60 with the driveshaft 36 that is coupled with the drive wheels 39a and 39b and that the sun gear and the carrier of the planetary gear 30 are respectively connected with the motor MG1 and the engine 22. As shown in FIG. 10, however, a hybrid vehicle 320 of a modification may be configured to connect a motor MG via the transmission 60 with the driveshaft 36 that is coupled with the drive wheels 39a and 39b and to connect the engine 22 with a rotating shaft of the motor MG via a clutch 329. Another modification may be configured to include a motor that is coupled with wheels 39c and 39d different from the drive wheels 39a and 39b, in addition to the configuration of the hybrid vehicle 320.

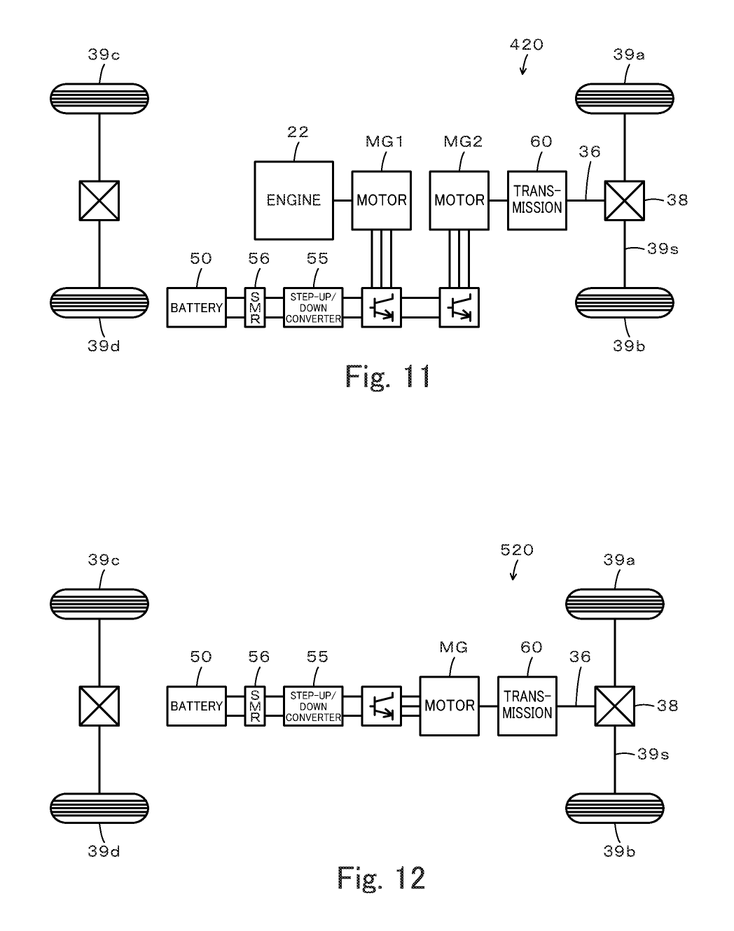

The hybrid vehicle 20 of the embodiment is configured such that the ring gear of the planetary gear 30 and the motor MG2 are connected via the transmission 60 with the driveshaft 36 that is coupled with the drive wheels 39a and 39b and that the sun gear and the carrier of the planetary gear 30 are respectively connected with the motor MG1 and the engine 22. As shown in FIG. 11, however, the present disclosure may also be implemented by a hybrid vehicle 420 of a modification that is configured as a series hybrid vehicle to connect a motor MG2 for driving via the transmission 60 with the driveshaft 36 that is coupled with the drive wheels 39a and 39b and to connect a motor MG1 for power generation with an output shaft of the engine 22. Another modification may be configured to exclude a transmission from the configuration of the hybrid vehicle 420 and to directly connect the driveshaft 36 with the motor MG2. Another modification may be configured to include a motor that is coupled with wheels 39c and 39d different from the drive wheels 39a and 39b, in addition to the configuration of the hybrid vehicle 420 or in addition to the configuration of excluding the transmission from the configuration of the hybrid vehicle 420.

The embodiment describes the hybrid vehicle 20 configured to include the engine 22 and the motors MG1 and MG2. As shown in FIG. 12, however, the present disclosure may also be implemented by an electric vehicle 520 of a modification that is configured to connect a motor MG for driving via the transmission 60 with the driveshaft 36 that is coupled with the drive wheels 39a and 39b. Another modification may be configured to exclude a transmission from the configuration of the electric vehicle 520 and to directly connect the driveshaft 36 with the motor MG. Another modification may be configured to include a motor that is coupled with wheels 39c and 39d different from the drive wheels 39a and 39b, in addition to the configuration of the electric vehicle 520 or in addition to the configuration of excluding the transmission from the configuration of the electric vehicle 520.

In the motor vehicle of the disclosure described above, when a rotation speed of the three-phase motor is equal to value 0 and a voltage of the capacitor becomes equal to or lower than a predetermined voltage after start of the three-phase ON control and the converter discharge control, the control device may be configured to terminate the three-phase ON control and the converter discharge control. The motor vehicle of this aspect suppresses an electric power caused by generation of a back electromotive force accompanied with the rotation of the three-phase motor from being supplied to the capacitor after termination of the three-phase ON control and the converter discharge control. This configuration accordingly suppresses the voltage of the capacitor from becoming higher than the predetermined voltage.

In the motor vehicle of the disclosure described above, when a rotation speed of the three-phase motor becomes equal to value 0 and a voltage of the capacitor is higher than a predetermined voltage after start of the three-phase ON control and the converter discharge control, the control device may be configured to terminate the three-phase ON control and to perform the converter discharge control and inverter discharge control that controls the inverter such as not to output a torque from the three-phase motor and such as to cause an electric charge of the capacitor to be consumed by the three-phase motor, and when the voltage of the capacitor becomes equal to or lower than the predetermined voltage, the control device may be configured to terminate the converter discharge control and the inverter discharge control. The motor vehicle of this aspect performs the converter discharge control and the inverter discharge control when the rotation speed of the three-phase motor becomes equal to the value 0 and the voltage of the capacitor is higher than the predetermined voltage after the relay is turned off in response to detection of a collision of the vehicle. This configuration accordingly further suppresses the time period from detection of a collision of the vehicle to the time when the voltage of the capacitor becomes equal to or lower than the predetermined voltage from being extended to a relatively long time.

The following describes the correspondence relationship between the primary elements of the above embodiment and the primary elements of the disclosure described in Summary. The motors MG1 and MG2 of the embodiment correspond to the “three-phase motor” of the disclosure. The inverters 41 and 42 correspond to the “inverter”. The battery 50 corresponds to the “battery”. The step-up/down converter 55 corresponds to the “step-up/down converter”. The capacitor 57 corresponds to the “capacitor”. The system main relay 56 corresponds to the “relay”. The HVECU 70 and the motor ECU 40 correspond to the “control device”.

The correspondence relationship between the primary components of the embodiment and the primary components of the present disclosure, regarding which the problem is described in Summary, should not be considered to limit the components of the present disclosure, regarding which the problem is described in Summary, since the embodiment is only illustrative to specifically describes the aspects of the present disclosure, regarding which the problem is described in Summary. In other words, the present disclosure, regarding which the problem is described in Summary, should be interpreted on the basis of the description in the Summary, and the embodiment is only a specific example of the present disclosure, regarding which the problem is described in Summary.

The aspect of the present disclosure is described above with reference to the embodiment. The present disclosure is, however, not limited to the above embodiment but various modifications and variations may be made to the embodiment without departing from the scope of the present disclosure.

### INDUSTRIAL APPLICABILITY

The above aspects of the present disclosure are applicable to, for example, the manufacturing industry of motor vehicles.

1. A motor vehicle, comprising:
a three-phase motor configured to output power to an axle;
an inverter configured to drive the three-phase motor by switching of a plurality of switching elements;
a battery;
a step-up/down converter configured to transmit electric power accompanied with a change in voltage between a low voltage-side power line which the battery is connected with and a high voltage-side power line which the inverter is connected with;
a capacitor mounted to the high voltage-side power line;
a relay provided in the low voltage-side power line; and
a control device configured to control the inverter, the step-up/down converter and the relay, wherein
in response to detection of a collision of the motor vehicle, the control device is configured to turn off the relay and to perform three-phase ON control that controls the inverter such as to turn on all switching elements of an upper arm or all switching elements of a lower arm among the plurality of switching elements and converter discharge control that controls the step-up/down converter such as to cause an electric charge of the capacitor to be consumed by the step-up/down converter.

2. The motor vehicle according to claim 1,
wherein when a rotation speed of the three-phase motor is equal to value 0 and a voltage of the capacitor becomes equal to or lower than a predetermined voltage after start of the three-phase ON control and the converter discharge control, the control device is configured to terminate the three-phase ON control and the converter discharge control.

3. The motor vehicle according to claim 1,
wherein when a rotation speed of the three-phase motor becomes equal to value 0 and a voltage of the capacitor is higher than a predetermined voltage after start of the three-phase ON control and the converter discharge control, the control device is configured to terminate the three-phase ON control and to perform the converter discharge control and inverter discharge control that controls the inverter such as not to output a torque from the three-phase motor and such as to cause an electric charge of the capacitor to be consumed by the three-phase motor, and
when the voltage of the capacitor becomes equal to or lower than the predetermined voltage, the control device is configured to terminate the converter discharge control and the inverter discharge control.
